(19) United States
(12) Patent Application Publication
(10) Pub. No.: US 2026/0171395 A1
(43) Pub. Date: Jun. 18, 2026

(54) POSITIVE ELECTRODE MATERIAL, POSITIVE ELECTRODE SHEET AND LITHIUM ION BATTERY

(71) Applicants: ZHEJIANG ZEEKR INTELLIGENT TECHNOLOGY CO., LTD., Ningbo (CN); VIRIDI E-MOBILITY TECHNOLOGY (NINGBO) CO., LTD., Ningbo (CN); ZHEJIANG GEELY HOLDING GROUP CO., LTD., Hangzhou (CN)

(72) Inventors: Jiejie WANG, Ningbo (CN); Peng DU, Ningbo (CN); Fuzhong PAN, Ningbo (CN); Tianchang GAO, Ningbo (CN)

(73) Assignees: ZHEJIANG ZEEKR INTELLIGENT TECHNOLOGY CO., LTD., Ningbo (CN); VIRIDI E-MOBILITY TECHNOLOGY (NINGBO) CO., LTD., Ningbo (CN); ZHEJIANG GEELY HOLDING GROUP CO., LTD., Hangzhou (CN)

(21) Appl. No.: 19/533,013

(22) Filed: Feb. 6, 2026

Related U.S. Application Data
(63) Continuation of application No. PCT/CN2024/130050, filed on Nov. 6, 2024.

(30) Foreign Application Priority Data
Dec. 15, 2023 (CN) 202311731060.6

(51) Int. Cl. H01M 4/36; C01B 25/45; C01G 53/506; H01M 4/525; H01M 4/58; H01M 10/0525

(52) U.S. Cl. CPC H01M 4/364; C01B 25/45; C01G 53/506; H01M 4/525; H01M 4/5825; H01M 10/0525; C01P 2002/54; C01P 2002/74; C01P 2004/61; C01P 2004/62; C01P 2004/80; C01P 2006/12; C01P 2006/40

(57) ABSTRACT

A positive electrode material is obtained by mixing a lithium manganese iron phosphate material and a ternary material. During mixing, a mass ratio n of the ternary material to the lithium manganese iron phosphate material in the positive electrode material is determined according to a range of a ratio k of an actual specific capacity of the ternary material to an actual specific capacity of the lithium manganese iron phosphate material. Specifically, when k is less than or equal to 1.34, n is 1 to 9; and when k is greater than 1.34, n is 0.1 to 1.

### CROSS-REFERENCE TO RELATED APPLICATIONS

This application is a continuation application of International Application No. PCT/CN2024/130050, filed on Nov. 6, 2024, which claims priority to Chinese Patent Application No. 202311731060.6, filed on Dec. 15, 2023. All of the aforementioned applications are incorporated herein by reference in their entireties.

### TECHNICAL FIELD

The present disclosure relates to the technical field of lithium ion battery, in particular to a positive electrode material, a positive electrode sheet, and a lithium ion battery.

### BACKGROUND

Lithium manganese iron phosphate combines safety and low cost. By using dissolved manganese to increase the voltage platform, its energy density can be improved by 10% to 20%, but this sacrifices the material's cycle and rate performance. Currently, not only is the content of dissolved manganese inconsistent, but there is also no fixed method for its application. Ternary materials are more expensive. Compared to high-nickel ternary materials, medium-nickel ternary materials have lower energy density. They typically improve energy density by increasing voltage at the expense of long-term performance. High-nickel ternary materials have even higher energy density, but their safety performance currently limits their rapid application.

A composite cathode system formed by blending lithium manganese iron phosphate and ternary materials can achieve a balanced energy density and safety performance. However, currently, for positive electrode materials obtained by mixing lithium manganese iron phosphate and ternary materials, when the mixing ratio of these two materials is improper, lithium ion batteries prepared using the positive electrode material are prone to problems such as low capacity retention, low cycle retention, and relatively high gas generation during cycling. In addition, for positive electrode materials obtained by mixing lithium manganese iron phosphate and ternary materials, lithium ion batteries prepared using the positive electrode material are difficult to simultaneously have suitable energy density, relatively high capacity retention, relatively high cycle retention, and relatively low gas generation during cycling.

### SUMMARY

Technical problems addressed by the present disclosure include at least one of the following problems: firstly, for a positive electrode material obtained by mixing lithium manganese iron phosphate and a ternary material, when a mixing ratio of the two materials is improper, a lithium ion battery prepared using the positive electrode material is prone to problems such as low capacity retention, low cycle retention, and relatively high gas generation during cycling; and secondly, for a positive electrode material obtained by mixing lithium manganese iron phosphate and a ternary material, a lithium ion battery prepared using the positive electrode material is difficult to simultaneously have appropriate energy density, relatively high capacity retention, relatively high cycle retention, and relatively low gas generation during cycling.

To solve the above-mentioned technical problems, the technical solution adopted in the present disclosure is as follows:
a positive electrode material, including w1 parts of an active material A and w2 parts of an active material B, where the active material Ais Liᵢ₁Mnₓ₁Fe_{y1}PO₄M_{f1}, and the active material Bis Liᵢ₂Niₓ₂CO_{y2}Mn_{z}O₂H_{f2},
where i1 ranges from 0.95 to 1.1, a ratio of x1 to y1 ranges from 0.5 to 4, a sum of x1 and y1 is 1, f1 ranges from 200 ppm to 3000 ppm, and M includes at least one of V, Al, Mo, Zr, Mg, Ti, W, Sr, Cr, La, and Ce; i2 ranges from 0.95 to 1.1, a sum of x2, y2, and z is 1, f2 ranges from 200 ppm to 8000 ppm, and H includes at least one of Al, Zr, Ti, Mg, Sr, W, Y, Nb, Ca, Mo, B, F, Ge, Sn, Ce, and Ta;
an actual specific capacity of the active material A is c1, an actual specific capacity of the active material B is c2, a ratio of c2 to c1 is k, and a ratio of w2 to w1 is n; when k is less than or equal to 1.34, n ranges from 1 to 9; and when k is greater than 1.34, n ranges from 0.1 to 1.

In an embodiment, D50 of the active material A ranges from 0.2 μm to 5 μm and a specific surface area of the active material A is not higher than 25 m²/g, and D50 of the active material B ranges from 2 μm to 13 μm and a specific surface area of the active material B is not higher than 1.5 m²/g.

In an embodiment, a particle size distribution of the active material A satisfies the following relationships: (D90−D50)/(D90−D10)≤0.96; and 0.03≤(D50−D10)/(D90−D50)≤0.24.

In an embodiment, a particle size distribution of the active material B satisfies the following relationships: (D50−D10)/(D90−D10)≤0.40; and 0.35≤(D50−D10)/(D90−D50)≤0.75.

In an embodiment, physical properties of the active material A and the active material B satisfy the following relationship:

$$0.95 \leq ( T 1 * T 2 * S 1 * S 2 ) / ( D 1 * D 2 * P 1 * P 2 ) \leq 1 \text{.15} ;$$

where T1 and T2 are tap densities of the active material A and the active material B, respectively; D1 and D2 are D50 values of the active material A and the active material B, respectively; P1 and P2 are powder compaction densities of the active material A and the active material B, respectively; and S1 and S2 are specific surface areas of the active material A and the active material B, respectively.

In an embodiment, three strongest peaks in an X-ray diffraction pattern of the active material A satisfy the following relationships:

$$0.99 \leq {I}_{a 1} / {I}_{a 2} \leq 1.39 , 0.74 \leq {F}_{a 1} / {F}_{a 2} \leq 1.14 ,$$

$$1.07 \leq {I}_{a 1} / {I}_{a 3} \leq 1.47 , and 0.82 \leq {F}_{a 1} / {F}_{a 3} \leq 1.22 ;$$

where Iₐ₁, Iₐ₂, and Iₐ₃ are intensities of a first strongest peak, a second strongest peak, and a third strongest peak of the active material A, respectively, and Fₐ₁, Fₐ₂, and Fₐ₃ are half-widths of the first strongest peak, the second strongest peak, and the third strongest peak of the active material A, respectively;
where three strongest peaks in an X-ray diffraction pattern of the active material B satisfy the following relationships:

$$1.23 \leq {I}_{b 1} / {I}_{b 2} \leq 1.63 , 0.6 \leq {F}_{b 1} / {F}_{b 2} \leq 1. ,$$

$$3.45 \leq {I}_{b 1} / {I}_{b 3} \leq 3.85 , and 0.67 \leq {F}_{b 1} / {F}_{b 3} \leq 1.07 ;$$

where I_{b1}, I_{b2}, and I_{b3} are intensities of a first strongest peak, a second strongest peak, and a third strongest peak of the active material B, respectively, and F_{b1}, F_{b2}, and F_{b3} are half-widths of the first strongest peak, the second strongest peak, and the third strongest peak of the active material B, respectively.

The present disclosure further provides a positive electrode sheet, including the positive electrode material described above.

The present disclosure further provides a lithium ion battery, including the positive electrode sheet described above.

In an embodiment, a compaction density of the positive electrode sheet ranges from 2.0 g/cm³ to 3.6 g/cm³.

In an embodiment, an electrolyte injection coefficient during a preparation process of the lithium ion battery is h, a ratio of a negative electrode capacity to a positive electrode capacity of the lithium ion battery is q, and a ratio of h to q ranges from 2.43 to 3.48.

Compared with the related art, the present disclosure uses a mixture of a lithium manganese iron phosphate material (the active material A) and a ternary cathode material (the active material B) as a positive electrode material. By mixing the lithium manganese iron phosphate material and the ternary cathode material having element ratios defined in the present disclosure as a positive electrode active material, an overall content proportion of transition metal ions in a positive electrode sheet obtained is moderate. In addition, in the present disclosure, during mixing of the lithium manganese iron phosphate material and the ternary material, a mass ratio n of the ternary material to the lithium manganese iron phosphate material in the positive electrode material is determined according to a range of a ratio k of an actual specific capacity of the ternary material to an actual specific capacity of the lithium manganese iron phosphate material. Specifically, when k is less than or equal to 1.34, n is 1 to 9; and when k is greater than 1.34, n is 0.1 to 1, so as to avoid the following situations: due to an improper mixing ratio of the two materials, a lithium ion battery prepared using the positive electrode material is prone to problems such as low capacity retention, low cycle retention, and severe gas generation during cycling. As a result, a lithium ion battery prepared from the positive electrode material is likely to simultaneously have relatively high energy density, relatively high capacity retention, relatively high cycle retention, and relatively low gas generation during cycling.

### DETAILED DESCRIPTION OF THE EMBODIMENTS

To make the above-mentioned objectives, features, and advantages of the present disclosure more apparent and easier to understand, specific embodiments of the present disclosure are described in detail below with reference to the accompanying drawings.

It should be noted that, in the absence of conflict, features in the embodiments of the present disclosure may be combined with each other. The terms “contain,” “include,” “including,” and “have” are non-limiting in meaning, that is, other steps and other components that do not affect the results may be added. The above terms cover the terms “consist of” and “consist essentially of.” Unless otherwise specified, materials, devices, and reagents are all commercially available. It should also be noted that, in the present disclosure, ppm represents parts per million.

An embodiment of the present disclosure provides a positive electrode material. Based on parts by weight, the positive electrode material includes w1 parts of an active material A, Liᵢ₁Mnₓ₁Fe_{y1}PO₄M_{f1}, and w2 parts of an active material B, Liᵢ₂Niₓ₂Co_{y2}Mn_{z}O₂H_{f2},
in which i1 ranges from 0.95 to 1.1, a ratio of x1 to y1 ranges from 0.5 to 4, a sum of x1 and y1 is 1, f1 ranges from 200 ppm to 3000 ppm, and M includes at least one of V, Al, Mo, Zr, Mg, Ti, W, Sr, Cr, La, and Ce; i2 ranges from 0.95 to 1.1, a sum of x2, y2, and z is 1, f2 ranges from 200 ppm to 8000 ppm, and H includes at least one of Al, Zr, Ti, Mg, Sr, W, Y, Nb, Ca, Mo, B, F, Ge, Sn, Ce, and Ta;
an actual specific capacity of the active material A is c1, an actual specific capacity of the active material B is c2, a ratio of c2 to c1 is k, and a ratio of w2 to w1 is n; when k is less than or equal to 1.34, n ranges from 1 to 9; and when k is greater than 1.34, n ranges from 0.1 to 1.

Compared with the prior art, in this embodiment, a lithium manganese iron phosphate material (the active material A) and a ternary cathode material (the active material B) are mixed and used as a positive electrode material. By mixing the lithium manganese iron phosphate material and the ternary cathode material having the element ratios defined in the present disclosure as a positive electrode active material, an overall content proportion of transition metal ions in a positive electrode sheet obtained is moderate. In addition, in this embodiment, during mixing of the lithium manganese iron phosphate material and the ternary material, based on a range of a ratio k of an actual specific capacity of the ternary material to an actual specific capacity of the lithium manganese iron phosphate material, a mass ratio n of the ternary material to the lithium manganese iron phosphate material in the positive electrode material is determined. Specifically, when k is less than or equal to 1.34, n is 1 to 9; and when k is greater than 1.34, n is 0.1 to 1, so as to avoid the following situations: due to an improper mixing ratio of the two materials, a lithium ion battery prepared using the positive electrode material is prone to problems such as low capacity retention, low cycle retention, and severe gas generation during cycling. As a result, a lithium ion battery prepared from the positive electrode material is likely to simultaneously have a relatively high energy density, a relatively high capacity retention, a relatively high cycle retention, and a relatively low amount of gas generation during cycling.

In this embodiment, the actual specific capacity c1 of the active material A, Liᵢ₁Mnₓ₁Fe_{y1}PO₄M_{f1}, is obtained by a coin cell test method. A 2032-type coin cell is taken as an example below to describe the test method. The specific process is as follows.

Using the active material A as a positive electrode active material, coin cells are prepared. Ten cells are selected for specific capacity testing, and an average value of obtained specific capacity data of the cells is taken to obtain the actual specific capacity c1 of the active material A. Process parameters involved in preparation of the 2032-type coin cells are as follows: a positive electrode formulation of conductive agent SP:binder PVDF:positive electrode active material=4:4:92, an aluminum foil used as a positive electrode current collector, metallic Li used as a counter electrode, lithium hexafluorophosphate used as an electrolyte, and Celgard2400 used as a separator. An areal coating density of a positive electrode slurry is controlled at 8.75±0.1 mg/cm², and a compaction density of a positive electrode sheet is 1.6 g/cm³.

A specific capacity test method for a single cell is as follows.

At a temperature of 25±2° C., a half cell is charged at a constant current of 0.1C to V₁, then charged at a constant voltage of V₁ until a current reaches 0.05C, and then discharged at a constant current of 0.1C to V₂, and the above process is cycled twice. A specific capacity of the cell is calculated based on a discharge capacity value of a second discharge, and a calculation formula is as follows:

$$C = {C}_{d i s c h a r g e} / [ ( {M}_{electrode} - {M}_{aluminum foil} ) * 0.92 ] ;$$

in which C_{discharge} is a capacity of the half cell after two cycles, M_{electrode} is a mass of a positive electrode sheet, M_{aluminum foil} is a mass of an aluminum foil current collector in the positive electrode sheet, V₁ is 4.5 V, and V₂ is 2 V.

In this embodiment, the actual specific capacity c2 of the active material B, Liᵢ₂Niₓ₂Co_{y2}Mn_{z}O₂H_{f2}, is obtained by a coin cell test method. A 2032-type coin cell is taken as an example below to describe the test method. The specific process is as follows.

Using the active material B as a positive electrode active material, coin cells are prepared. Ten cells are selected for specific capacity testing, and an average value of obtained specific capacity data of the cells is taken to obtain the actual specific capacity c2 of the active material B. Process parameters involved in preparation of the 2032-type coin cells are as follows: a positive electrode formulation of conductive agent SP:binder PVDF:positive electrode active material=4:4:92, an aluminum foil used as a positive electrode current collector, metallic Li used as a counter electrode, lithium hexafluorophosphate used as an electrolyte, and Celgard2400 used as a separator. An areal coating density of a positive electrode slurry is controlled at 8.75±0.1 mg/cm², and a compaction density of a positive electrode sheet is 2.6 g/cm³.

A specific capacity test method for a single cell is as follows.

At a temperature of 25±2° C., a half cell is charged at a constant current of 0.1C to V₁, then charged at a constant voltage of V₁ until a current reaches 0.05C, and then discharged at a constant current of 0.1C to V₂, and the above process is cycled twice. A specific capacity of the cell is calculated based on a discharge capacity value of a second discharge, and a calculation formula is as follows:

$$C = {C}_{d i s c h a r g e} / [ ( {M}_{electrode} - {M}_{aluminum foil} ) * 0.92 ] ;$$

in which C_{discharge} is a capacity of the half cell after two cycles, M_{electrode} is a mass of a positive electrode sheet, and M_{aluminum foil} is a mass of an aluminum foil current collector in the positive electrode sheet. When x2 is less than 0.8, V₁ is 4.4 V and V₂ is 3.0 V; when x2 is greater than or equal to 0.8, V₁ is 4.3 V and V₂ is 3.0 V.

In some embodiments of the present disclosure, D50 of the active material A ranges from 0.2 μm to 5 μm, and a specific surface area of the active material A is not higher than 25 m²/g. A particle size distribution of the active material A satisfies the following relationships:

$$( D 90 - D 50 ) / ( D 90 - D 10 ) \leq 0.96 ; \\ and 0.03 \leq ( D 50 - D 10 ) / ( D 90 - D 50 ) \leq 0.24 .$$

The active material A has relatively poor conductivity. A large amount of large particles in the active material A causes an increase in a lithium ion transport path and an increase in impedance, thereby affecting capacity performance of the active material A. In the present disclosure, by controlling particle size and particle size distribution of the active material A in the positive electrode material, excessive large particles of the active material A in the positive electrode material are avoided, so that an advantage of high energy density of the active material A is fully utilized, and a lithium ion battery prepared using the positive electrode material is ensured to have a relatively appropriate energy density.

In some embodiments of the present disclosure, D50 of the active material B ranges from 2 μm to 13 μm, and a specific surface area of the active material B is not higher than 1.5 m²/g. A particle size distribution of the active material B satisfies the following relationships:

$$( D 50 - D 10 ) / ( D 90 - D 10 ) \leq 0.4 ; \\ and 0.35 \leq ( D 50 - D 10 ) / ( D 90 - D 50 ) \leq 0.75 .$$

When an amount of small particles of the active material B increases, side reactions increase, resulting in an increase in gas generation during cycling of a lithium ion battery. In the present disclosure, by controlling particle size and particle size distribution of the active material B in the positive electrode material, excessive small particles of the active material B in the positive electrode material are avoided.

In some embodiments of the present disclosure, physical property parameters of the active material A and the active material B satisfy the following relationship:

$$0.95 \leq ( T 1 * T 2 * S 1 * S 2 ) / ( D 1 * D 2 * P 1 * P 2 ) \leq 1.15 ,$$

in which T1 and T2 are tap densities of the active material A and the active material B, respectively; D1 and D2 are D50 values of the active material A and the active material B, respectively; P1 and P2 are powder compaction densities of the active material A and the active material B, respectively; and S1 and S2 are specific surface areas of the active material A and the active material B, respectively.

In some embodiments of the present disclosure, three strongest peaks in an X-ray diffraction pattern of the active material A satisfy the following relationships:

$$0.99 \leq {I}_{a 1} / {I}_{a 2} \leq 1.39 , 0.74 \leq {F}_{a 1} / {F}_{a 2} \leq 1.14 , \\ 1.07 \leq {I}_{a 1} / {I}_{a 3} \leq 1.47 , and 0.82 \leq {F}_{a 1} / {F}_{a 3} \leq 1.22 ;$$

in which Iₐ₁, Iₐ₂, and Iₐ₃ are intensities of a first strongest peak, a second strongest peak, and a third strongest peak of the active material A, respectively, and Fₐ₁, Fₐ₂, and Fₐ₃ are half-widths of the first strongest peak, the second strongest peak, and the third strongest peak of the active material A, respectively;
three strongest peaks in an X-ray diffraction pattern of the active material B satisfy the following relationships:

$$1.23 \leq {I}_{b 1} / {I}_{b 2} \leq 1.63 , 0.6 \leq {F}_{b 1} / {F}_{b 2} \leq 1. ,$$

$$3.45 \leq {I}_{b 1} / {I}_{b 3} \leq 3.85 , and 0.67 \leq {F}_{b 1} / {F}_{b 3} \leq 1.07 ;$$

in which I_{b1}, I_{b2}, and I_{b3} are intensities of a first strongest peak, a second strongest peak, and a third strongest peak of the active material B, respectively, and F_{b1}, F_{b2}, and F_{b3} are half-widths of the first strongest peak, the second strongest peak, and the third strongest peak of the active material B, respectively.

Intensities and half-widths of three strongest peaks of a material reflect crystal crystallinity of the material, and crystal crystallinity of the material affects performance of the material.

The present disclosure further provides a positive electrode sheet, including the positive electrode material described above.

The present disclosure further provides a lithium ion battery, including the positive electrode sheet described above. A compaction density of the positive electrode sheet is 2.0 g/cm³ to 3.6 g/cm³. During a preparation process of the lithium ion battery, an electrolyte injection coefficient is h, a ratio of a negative electrode capacity to a positive electrode capacity of the lithium ion battery is q, and a ratio of h to q is 2.43 to 3.48.

The present disclosure will be further illustrated below with reference to specific embodiments. It should be understood that these embodiments are for illustrative purposes only and are not intended to limit the scope of the present disclosure.

### First Embodiment

Based on parts by weight, in this embodiment, the positive electrode material includes w1 parts of an active material A, LiMn_{0.6}Fe_{0.4}PO₄M_{f1}, and w2 parts of an active material B, LiNi_{0.6}Co_{0.1}Mn_{0.3}O₂H_{f2}. In this embodiment, f1 is 500 ppm and M is Ti; f2 is 2000 ppm and H is Zr.

After testing, an actual specific capacity c1 of the active material A is 152 mAh/g, and an actual specific capacity c2 of the active material B is 220 mAh/g. A ratio of c2 to c1 is k, and a ratio of w2 to w1 is n.

In this embodiment, k is 1.45 and n is 0.25. For the active material A, D90 is 4.72 μm, D50 is 0.556 μm, and D10 is 0.302 μm, (D90−D50)/(D90−D10) is 0.94, and (D50−D10)/(D90−D50) is 0.06. A particle size distribution satisfies the following relationships: (D90−D50)/(D90−D10)≤0.96, and 0.03≤(D50−D10)/(D90−D50)≤0.24;
for the active material B, D90 is 6.939 μm, D50 is 3.917 μm, and D10 is 2.158 μm, (D50−D10)/(D90−D10) is 0.36, and (D50−D10)/(D90−D50) is 0.56. A particle size distribution satisfies the following relationships:

$$( D 50 - D 10 ) / ( D 90 - D 10 ) \leq 0.4 , \\ and 0.35 \leq ( D 50 - D 10 ) / ( D 90 - D 50 ) \leq 0.75 .$$

In this embodiment, physical property parameters of the active material A and the active material B satisfy the following relationship:

$$0.95 \leq ( T 1 * T 2 * S 1 * S 2 ) / ( D 1 * D 2 * P 1 * P 2 ) \leq 1 \text{.15} ;$$

in which T1 and T2 are tap densities of the active material A and the active material B, respectively, D1 and D2 are D50 values of the active material A and the active material B, respectively, P1 and P2 are powder compaction densities of the active material A and the active material B, respectively, and S1 and S2 are specific surface areas of the active material A and the active material B, respectively. Specifically, in this embodiment, T1 and T2 are 0.593 g/cm³ and 1.93 g/cm³, respectively, D1 and D2 are 0.556 μm and 3.917 μm, respectively, P1 and P2 are 2.205 g/cm³ and 3.127 g/cm³, respectively, and S1 and S2 are 19.43 m²/g and 0.716 m²/g, respectively.

Relationships among intensities of three strongest peaks in an X-ray diffraction pattern of the active material A are as follows: \textcircled{1} Iₐ₁/Iₐ₂=1.19 and Fₐ₁/Fₐ₂=0.94, and \textcircled{2} Iₐ₁/Lₐ₃=1.27 and Fₐ₁/Fₐ₃=1.02.

The three strongest peaks satisfy the following relationships:

$$0.99 \leq {I}_{a 1} / {I}_{a 2} \leq 1.39 , 0.74 \leq {F}_{a 1} / {F}_{a 2} \leq 1.14 , \\ 1.07 \leq {I}_{a 1} / {I}_{a 3} \leq 1.47 , and 0.82 \leq {F}_{a 1} / {F}_{a 3} \leq 1.22 ;$$

in which Iₐ₁, Iₐ₂, and Iₐ₃ are intensities of a first strongest peak, a second strongest peak, and a third strongest peak of the active material A, respectively, and Fₐ₁, Fₐ₂, and Fₐ₃ are half-widths of the first strongest peak, the second strongest peak, and the third strongest peak of the active material A, respectively.

Relationships among intensities of three strongest peaks in an X-ray diffraction pattern of the active material B are as follows: I_{b1}/I_{b2}=1.43 and F_{b1}/F_{b2}=0.8, and I_{b1}/I_{b3}=3.65 and F_{b1}/F_{b3}=0.87.

The three strongest peaks satisfy the following relationships:

$$1.23 \leq {I}_{b 1} / {I}_{b 2} \leq 1.63 , 0.6 \leq {F}_{b 1} / {F}_{b 2} \leq 1. , \\ 3.45 \leq {I}_{b 1} / {I}_{b 3} \leq 3.85 , 0.67 \leq {F}_{b 1} / {F}_{b 3} \leq 1.07 ;$$

in which I_{b1}, I_{b2}, and I_{b3} are intensities of a first strongest peak, a second strongest peak, and a third strongest peak of the active material B, respectively, and F_{b1}, F_{b2}, and F_{b3} are half-widths of the first strongest peak, the second strongest peak, and the third strongest peak of the active material B, respectively.

A lithium ion battery is prepared using the positive electrode material in this embodiment. During preparation of the lithium ion battery, a double-sided coating areal density of a positive electrode is 372 g/m², a compaction density of a positive electrode sheet after roll pressing is 2.5 g/cm³, an electrolyte injection coefficient h is 3.6, a ratio q of a negative electrode capacity to a positive electrode capacity of the lithium ion battery is 1.08, and a ratio of h to q is 3.3.

### Second Embodiment

Based on parts by weight, in this embodiment, the positive electrode material includes w1 parts of an active material A, LiMn_{0.6}Fe_{0.4}PO₄M_{f1}, and w2 parts of an active material B, LiNi_{0.6}Co_{0.1}Mn_{0.3}O₂H_{f2}. In this embodiment, f1 is 500 ppm and M is Ti; f2 is 2000 ppm and H is Zr.

After testing, an actual specific capacity c1 of the active material A is 152 mAh/g, and an actual specific capacity c2 of the active material B is 197 mAh/g. A ratio of c2 to c1 is k, and a ratio of w2 to w1 is n.

In this embodiment, k is 1.30 and n is 4. For the active material A, D90 is 4.72 μm, D50 is 0.556 μm, and D10 is 0.302 μm, (D90−D50)/(D90−D10) is 0.94, and (D50−D10)/(D90−D50) is 0.06. A particle size distribution satisfies the following relationships:

$$( D 90 - D 50 ) / ( D 90 - D 10 ) \leq 0.96 ; and \\ 0.03 \leq ( D 50 - D 10 ) / ( D 90 - D 50 ) \leq 0 \text{.24} ;$$

for the active material B, D90 is 6.920 μm, D50 is 3.920 μm, and D10 is 2.155 μm, (D50−D10)/(D90−D10) is 0.37, and (D50−D10)/(D90−D50) is 0.59. A particle size distribution satisfies the following relationships:

$$( D 50 - D 10 ) / ( D 90 - D 10 ) \leq 0.4 ; and \\ 0.35 \leq ( D 50 - D 10 ) / ( D 90 - D 50 ) \leq 0.75 .$$

In this embodiment, physical property parameters of the active material A and the active material B satisfy the following relationship:

$$0.95 \leq ( T 1 * T 2 * S 1 * S 2 ) / ( D 1 * D 2 * P 1 * P 2 ) \leq 1 \text{.15} ;$$

in which T1 and T2 are tap densities of the active material A and the active material B, respectively, D1 and D2 are D50 values of the active material A and the active material B, respectively, P1 and P2 are powder compaction densities of the active material A and the active material B, respectively, and S1 and S2 are specific surface areas of the active material A and the active material B, respectively. Specifically, in this embodiment, T1 and T2 are 0.593 g/cm³ and 1.928 g/cm³, respectively, D1 and D2 are 0.556 μm and 3.920 μm, respectively, P1 and P2 are 2.205 g/cm³ and 3.124 g/cm³, respectively, and S1 and S2 are 19.43 m²/g and 0.713 m²/g, respectively.

Relationships among intensities of three strongest peaks in an X-ray diffraction pattern of the active material A are as follows: \textcircled{1} Lₐ₁/Iₐ₂=1.19 and Fₐ₁/Fₐ₂=0.94, and \textcircled{2} Lₐ₁/Iₐ₃=1.27 and Fₐ₁/Fₐ₃=1.02.

The relationships satisfy the following conditions:

$$0.99 \leq {I}_{a 1} / {I}_{a 2} \leq 1.39 , 0.74 \leq {F}_{a 1} / {F}_{a 2} \leq 1.14 , \\ 1.07 \leq {I}_{a 1} / {I}_{a 3} \leq 1.47 , and \\ 0.82 \leq {F}_{a 1} / {F}_{a 3} \leq 1.22 ;$$

in which Ia1, Ia2, and Ia3 are intensities of a first strongest peak, a second strongest peak, and a third strongest peak of the active material A, respectively, and Fa1, Fa2, and Fa3 are half-widths of the first strongest peak, the second strongest peak, and the third strongest peak of the active material A, respectively.

Relationships among intensities of three strongest peaks in an X-ray diffraction pattern of the active material B are as follows: Ib1/Ib2=1.45 and Fb1/Fb2=0.81, and Ib1/Ib3=3.61 and Fb1/Fb3=0.91.

The three strongest peaks satisfy the following relationships:

$$1.23 \leq {I}_{b 1} / {I}_{b 2} \leq 1.63 , 0.6 \leq {F}_{b 1} / {F}_{b 2} \leq 1. , \\ 3.45 \leq {I}_{b 1} / {I}_{b 3} \leq 3.85 , and \\ 0.67 \leq {F}_{b 1} / {F}_{b 3} \leq 1.07 ;$$

in which Ib1, Ib2, and Ib3 are intensities of a first strongest peak, a second strongest peak, and a third strongest peak of the active material B, respectively, and Fb1, Fb2, and Fb3 are half-widths of the first strongest peak, the second strongest peak, and the third strongest peak of the active material B, respectively.

A lithium ion battery is prepared using the positive electrode material in this embodiment. During preparation of the lithium ion battery, a double-sided coating areal density of a positive electrode is 372 g/m², a compaction density of a positive electrode sheet after roll pressing is 2.5 g/cm³, an electrolyte injection coefficient h is 3.6, a ratio q of a negative electrode capacity to a positive electrode capacity of the lithium ion battery is 1.08, and a ratio of h to q is 3.3.

### Third Embodiment

The difference from the first embodiment lies in that n is 1, and the rest are the same as those in the first embodiment.

### Fourth Embodiment

The difference from the first embodiment lies in that n is 0.1, and the rest are the same as those in the first embodiment.

### Fifth Embodiment

The difference from the second embodiment lies in that n is 1, and the rest are the same as those in the second embodiment.

### Sixth Embodiment

The difference from the second embodiment lies in that n is 9, and the rest are the same as those in the second embodiment.

### First Comparative Example

The difference from the first embodiment lies in that n is 1.3, and the rest are the same as those in the first embodiment.

### Second Comparative Example

The difference from the second embodiment lies in that n is 0.25, and the rest are the same as those in the second embodiment.

### Third Comparative Example

The positive electrode material is the active material A in the first embodiment, and a preparation method of the lithium ion battery is the same as that in the first embodiment.

### Fourth Comparative Example

The positive electrode material is the active material B in the first embodiment, and a preparation method of the lithium ion battery is the same as that in the first embodiment.

### Fifth Comparative Example

The difference from the first embodiment lies in that, for the active material A, D90 is 1.52 μm, D50 is 0.9 μm, and D10 is 0.4 μm, (D90−D50)/(D90−D10) is 1.2, and (D50−D10)/(D90−D50) is 0.81. The particle size distribution does not satisfy the following relationships:

$$( D 90 - D 50 ) / ( D 90 - D 10 ) \leq 0.96 ; and \\ 0.03 \leq ( D 50 - D 10 ) / ( D 90 - D 50 ) \leq 0 \text{.24} ;$$

the rest are the same as those in the first embodiment.

### Sixth Comparative Example

The difference from the first embodiment lies in that, for the active material B, D90 is 6.5 μm, D50 is 3.6 μm, and D10 is 0.9 μm, (D50−D10)/(D90−D10) is 0.48, and (D50−D10)/(D90−D50) is 0.93. The particle size distribution does not satisfy the following relationships:

$$( D 50 - D 10 ) / ( D 90 - D 10 ) \leq 0.4 ; and \\ 0.35 \leq ( D 50 - D 10 ) / ( D 90 - D 50 ) \leq 0.75 .$$

The rest are the same as those in the first embodiment.

### Seventh Comparative Example

The difference from the first embodiment lies in that relationships among intensities of three strongest peaks in an X-ray diffraction pattern of the active material A are as follows: \textcircled{1} Ia1/Ia2=0.9 and Fa1/Fa2=0.68, and (2) Ia1/Ia3=0.98 and Fa1/Fa3=0.76.

The three strongest peaks do not satisfy the following relationships:

$$0.99 \leq {I}_{a 1} / {I}_{a 2} \leq 1.39 , 0.74 \leq {F}_{a 1} / {F}_{a 2} \leq 1.14 , \\ 1.07 \leq {I}_{a 1} / {I}_{a 3} \leq 1.47 , and \\ 0.82 \leq {F}_{a 1} / {F}_{a 3} \leq 1.22 ;$$

the rest are the same as those in the first embodiment.

### Eighth Comparative Example

The difference from the first embodiment lies in that physical property parameters of the active material A and the active material B do not satisfy the following relationship:

$$0.95 \leq ( T 1 * T 2 * S 1 * S 2 ) / ( D 1 * D 2 * P 1 * P 2 ) \leq 1 \text{.15} ;$$

in which T1 and T2 are tap densities of the active material A and the active material B, respectively, D1 and D2 are D50 values of the active material A and the active material B, respectively, P1 and P2 are powder compaction densities of the active material A and the active material B, respectively, and S1 and S2 are specific surface areas of the active material A and the active material B, respectively. Specifically, in this comparative example, parameters related to the active material A are changed: T1 and T2 are 0.45 g/cm³ and 1.93 g/cm³, respectively, D1 and D2 are 0.55 μm and 3.917 μm, respectively, P1 and P2 are 2.20 g/cm³ and 3.127 g/cm³, respectively, and S1 and S2 are 22 m²/g and 0.716 m²/g, respectively.

The rest are the same as those in the first embodiment.

### Ninth Comparative Example

The difference from the first embodiment lies in that an electrolyte injection coefficient h is 2.3, a ratio q of a negative electrode capacity to a positive electrode capacity of the lithium ion battery is 1.08, and a ratio of h to q is 2.13. The rest are the same as those in the first embodiment.

### Experimental Example

Batteries prepared in the first embodiment to sixth embodiment and the first comparative example to ninth comparative example are respectively tested for ultimate compaction density, full-cell specific capacity utilization, rate performance, capacity retention, cycle retention, and gas generation during cycling, and results are shown in Table 1.

It can be seen from Table 1 that lithium ion batteries prepared using positive electrode materials in the first embodiment to sixth embodiment simultaneously have relatively high full-cell specific capacity utilization, relatively high capacity retention, relatively good cycling performance, and relatively good safety performance. It can be seen that, under an appropriate mixing ratio, the active material A provides a favorable coating effect on the active material B, reduces side reactions of the active material B, and stabilizes an interface, and under the appropriate mixing ratio, the active material B improves energy density of the active material A, enhances rate performance, reduces dissolution of Mn elements, and improves storage performance and cycling performance.

Compared with the first embodiment, the third embodiment, and the fourth embodiment, in the first comparative example, due to an excessive proportion of the ternary material, capacity retention, cycle retention, and gas generation during cycling of the lithium ion battery are severely deteriorated. Compared with the second embodiment, the fourth embodiment, and the fifth embodiment, in the second comparative example, due to an insufficient proportion of the ternary material, capacity retention, cycle retention, and gas generation during cycling of the lithium ion battery are also severely deteriorated. Compared with the fourth embodiment, in the third comparative example, under a boundary mixing ratio, a small amount of the ternary material (the active material B) is mixed into the lithium manganese iron phosphate material (the active material A). Since the ternary material has a faster ion diffusion rate, rate performance is improved, and improvements in storage performance and cycling performance are more significant. Compared with the sixth embodiment, in fourth comparative example, under a boundary mixing ratio, a small amount of the lithium manganese iron phosphate material (the active material A) is mixed into the ternary material (the active material B). Since the lithium manganese iron phosphate material improves an interface of the ternary material and reduces side reactions, cycling performance can be effectively improved. From the above analysis, it can be seen that, when the lithium manganese iron phosphate material (the active material A) and the ternary material (the active material B) are mixed, it is necessary to determine a mass ratio n of the ternary material to the lithium manganese iron phosphate material in the positive electrode material according to a range of a ratio k of an actual specific capacity of the ternary material to an actual specific capacity of the lithium manganese iron phosphate material. Specifically, when k is less than or equal to 1.34, nis 1 to 9; and when k is greater than 1.34, nis 0.1 to 1, so as to avoid the following situations: due to an improper mixing ratio of the two materials, a lithium ion battery prepared using the positive electrode material is prone to problems such as low capacity retention, low cycle retention, and severe gas generation during cycling.

It can be seen from Table 1 that, compared with the first embodiment, in the fifth comparative example, full-cell specific capacity utilization of the lithium ion battery is reduced and rate performance is deteriorated. This is because a particle size distribution of the active material A is changed, with more large particles and poorer conductivity, resulting in reduced full-cell specific capacity utilization and deteriorated rate performance.

Compared with the first embodiment, in the sixth comparative example, capacity retention and cycle retention of the lithium ion battery are reduced, and gas generation during cycling is increased. This is because a particle size distribution of the active material B is changed, with more small particles and more severe side reactions, resulting in reduced capacity retention, reduced cycle retention, and increased gas generation during cycling.

Compared with the first embodiment, in the seventh comparative example, compaction density of an electrode sheet of the lithium ion battery is reduced, capacity retention is reduced, cycle retention is reduced, and gas generation during cycling is increased. This is because crystal structure development of the active material A is relatively poor.

Compared with the first embodiment, in the eighth comparative example, compaction density of an electrode sheet of the lithium ion battery is significantly reduced.

Compared with the first embodiment, in the ninth comparative example, capacity retention and cycle retention of the lithium ion battery are reduced.

In summary, when the lithium manganese iron phosphate material (the active material A) and the ternary material (the active material B) are mixed, it is necessary to determine a mass ratio n of the ternary material to the lithium manganese iron phosphate material in the positive electrode material according to a range of a ratio k of an actual specific capacity of the ternary material to an actual specific capacity of the lithium manganese iron phosphate material. Specifically, when k is less than or equal to 1.34, n is 1 to 9; and when k is greater than 1.34, n is 0.1 to 1, so as to avoid the following situations: due to an improper mixing ratio of the two materials, a lithium ion battery prepared using the positive electrode material is prone to problems such as low capacity retention, low cycle retention, and severe gas generation during cycling. To enable the lithium ion battery to simultaneously have relatively high energy density, relatively high capacity retention, relatively good cycling performance, and relatively good safety performance, in addition to controlling an appropriate mixing ratio, it is also necessary to strictly control particle size distribution, crystal structure, tap density, powder compaction density, specific surface area, and the like of the two mixed materials.

TABLE 1

| | | | | | | Gas |
|---|---|---|---|---|---|---|
| | | Full-cell | | | Room- | generation |
| | | specific | | | temperature | during |
| | | capacity | | Capacity | cycle | cycling |
| | Ultimate | utilization | Rate | retention/capacity | retention | (ml/Ah |
| | compaction | (mAh/g @ | performance | recovery at | (500 | @ 500 |
| | density | 0.33C) | (3C/0.33C) | 60° C. (30 d) | cycles) | cycles) |
| First | 2.60 | 149 | 92.5% | 94.5%/95.5% | 93.5% | 0.5 |
| embodiment | | | | | | |
| Second | 3.3 | 182 | 92% | 94.9%/95.6% | 93.6% | 0.4 |
| embodiment | | | | | | |
| Third | 2.9 | 173 | 92.5% | 93%/94% | 92% | 0.7 |
| embodiment | | | | | | |
| Fourth | 2.46 | 145 | 91.9% | 90.5%/91.4% | 91.5% | 0.55 |
| embodiment | | | | | | |
| Fifth | 2.9 | 165.5 | 92.6% | 95%/95.7% | 93.9% | 0.6 |
| embodiment | | | | | | |
| Sixth | 3.34 | 187.5 | 93.1% | 90.1%/91.5% | 93.8. | 0.4 |
| embodiment | | | | | | |
| First | 3.40 | 178 | 93% | 92.3/93.1% | 90.1% | 1.0 |
| comparative | | | | | | |
| example | | | | | | |
| Second | 2.57 | 149 | 92.5% | 91.5%/92% | 91% | 0.8 |
| comparative | | | | | | |
| example | | | | | | |
| Third | 2.35 | 138 | 91.7% | 89.7%/91.2% | 88.1% | 1.1 |
| comparative | | | | | | |
| example | | | | | | |
| Fourth | 3.45 | 193 | 94.1% | 90.6%/91.0% | 89.5% | 0.9 |
| comparative | | | | | | |
| example | | | | | | |
| Fifth | 2.62 | 147 | 91.5% | 94.2%/95.6% | 92.2% | 0.5 |
| comparative | | | | | | |
| example | | | | | | |
| Sixth | 2.58 | 150 | 92.8% | 93.8%/95.2% | 91.9% | 0.8 |
| comparative | | | | | | |
| example | | | | | | |
| Seventh | 2.51 | 149.1 | 92.5% | 91.2%/91.9% | 91.6% | 0.8 |
| comparative | | | | | | |
| example | | | | | | |
| Eighth | 2.29 | 149.2 | 93% | 94.3%/95.2% | 93.1% | 0.6 |
| comparative | | | | | | |
| example | | | | | | |
| Ninth | 2.6 | 149 | 91.1% | 90.1%/90.8% | 85.2% | 0.51 |
| comparative | | | | | | |
| example | | | | | | |

Some lithium ion battery performance test methods involved in the present disclosure are as follows:

Rate performance: charging is performed in accordance with single-cell requirements in GB/T 31486-2015 “Cycle life requirements and test methods for traction batteries for electric vehicles.” After constant-capacity cycling for two cycles at 0.33C, a constant-capacity value of a second cycle is used as a 0.33C discharge calibration capacity, and then charging at 0.33C and discharging at 3C are performed for two cycles. A capacity of a second cycle is used as a 3C discharge calibration capacity, and a ratio of the 3C calibration capacity to the 0.33C calibration capacity is used to quantify rate performance.

Cycling test: cycling tests are performed in accordance with cycle life test requirements of GB/T 31484-2015 “Cycle life requirements and test methods for traction batteries for electric vehicles.” A capacity retention after 500 cycles and a gas generation amount after 500 cycles are obtained.

High-temperature storage performance test: fully charged batteries are stored in a constant-temperature chamber at 60° C. for 60 d, and capacity retention and capacity recovery are measured.

Ultimate compaction density test: positive electrode sheets are roll-pressed, and a compaction density of the positive electrode sheets at a critical state before brittle failure is measured.

Full-cell specific capacity utilization test: charging is performed in accordance with single-cell requirements in GB/T 31486-2015 “Cycle life requirements and test methods for traction batteries for electric vehicles.” After constant-capacity cycling for two cycles at 0.33C, a constant-capacity value of a second cycle is used as full-cell specific capacity utilization.

In addition, it should be noted that although the present disclosure is disclosed as described above, the scope of protection of the present disclosure is not limited thereto. Those skilled in the art may make various changes and modifications without departing from the spirit and scope of the present disclosure, and such changes and modifications shall all fall within the scope of protection of the present disclosure.

What is claimed is:

1. A positive electrode material, comprising w1 parts of an active material A and w2 parts of an active material B, wherein the active material A is Liᵢ₁Mnₓ₁Fe_{y1}PO₄M_{f1}, and the active material Bis Liᵢ₂ Niₓ₂Co_{y2}Mn_{z}O₂H_{f2},
wherein i1 ranges from 0.95 to 1.1, a ratio of x1 to y1 ranges from 0.5 to 4, a sum of x1 and y1 is 1, f1 ranges from 200 ppm to 3000 ppm, and M comprises at least one of V, Al, Mo, Zr, Mg, Ti, W, Sr, Cr, La, and Ce; i2 ranges from 0.95 to 1.1, a sum of x2, y2, and z is 1, f2 ranges from 200 ppm to 8000 ppm, and H comprises at least one of Al, Zr, Ti, Mg, Sr, W, Y, Nb, Ca, Mo, B, F, Ge, Sn, Ce, and Ta; and
an actual specific capacity of the active material A is c1, an actual specific capacity of the active material B is c2, a ratio of c2 to c1 is k, and a ratio of w2 to w1 is n; when k is less than or equal to 1.34, n ranges from 1 to 9; and when k is greater than 1.34, n ranges from 0.1 to 1.

2. The positive electrode material according to claim 1, wherein D50 of the active material A ranges from 0.2 μm to 5 μm and a specific surface area of the active material A is not higher than 25 m²/g, and D50 of the active material B ranges from 2 μm to 13 μm and a specific surface area of the active material B is not higher than 1.5 m²/g.

3. The positive electrode material according to claim 2, wherein a particle size distribution of the active material A satisfies the following relationships:
$$( D 90 - D 50 ) / ( D 90 - D 10 ) \leq 0.96 ; and \\ 0.03 \leq ( D 50 - D 10 ) / ( D 90 - D 50 ) \leq 0.24 .$$

4. The positive electrode material according to claim 2, wherein a particle size distribution of the active material B satisfies the following relationships:
$$( D 50 - D 10 ) / ( D 90 - D 10 ) \leq 0.4 ; and \\ 0.35 \leq ( D 50 - D 10 ) / ( D 90 - D 50 ) \leq 0.75 .$$

5. The positive electrode material according to claim 1, wherein physical properties of the active material A and the active material B satisfy the following relationship:
$$0.95 \leq ( T 1 * T 2 * S 1 * S 2 ) / ( D 1 * D 2 * P 1 * P 2 ) \leq 1 \text{.15} ;$$
wherein T1 and T2 are tap densities of the active material A and the active material B, respectively; D1 and D2 are D50 values of the active material A and the active material B, respectively; P1 and P2 are powder compaction densities of the active material A and the active material B, respectively; and S1 and S2 are specific surface areas of the active material A and the active material B, respectively.

6. The positive electrode material according to claim 1, wherein three strongest peaks in an X-ray diffraction pattern of the active material A satisfy the following relationships:
$$0.99 \leq {I}_{a 1} / {I}_{a 2} \leq 1.39 , 0.74 \leq {F}_{a 1} / {F}_{a 2} \leq 1.14 , \\ 1.07 \leq {I}_{a 1} / {I}_{a 3} \leq 1.47 , and \\ 0.82 \leq {F}_{a 1} / {F}_{a 3} \leq 1.22 ;$$
wherein Iₐ₁, Iₐ₂, and Iₐ₃ are intensities of a first strongest peak, a second strongest peak, and a third strongest peak of the active material A, respectively, and Fₐ₁, Fₐ₂, and Fₐ₃ are half-widths of the first strongest peak, the second strongest peak, and the third strongest peak of the active material A, respectively;
wherein three strongest peaks in an X-ray diffraction pattern of the active material B satisfy the following relationships:
$$1.23 \leq {I}_{b 1} / {I}_{b 2} \leq 1.63 , 0.6 \leq {F}_{b 1} / {F}_{b 2} \leq 1. , \\ 3.45 \leq {I}_{b 1} / {I}_{b 3} \leq 3.85 , and \\ 0.67 \leq {F}_{b 1} / {F}_{b 3} \leq 1.07 ;$$
wherein I_{b1}, I_{b2}, and I_{b3} are intensities of a first strongest peak, a second strongest peak, and a third strongest peak of the active material B, respectively, and F_{b1}, F_{b2}, and F_{b3} are half-widths of the first strongest peak, the second strongest peak, and the third strongest peak of the active material B, respectively.

7. A positive electrode sheet, comprising the positive electrode material according to claim 1.

8. A lithium ion battery, comprising the positive electrode sheet according to claim 7.

9. The lithium ion battery according to claim 8, wherein a compaction density of the positive electrode sheet ranges from 2.0 g/cm³ to 3.6 g/cm³.

10. The lithium ion battery according to claim 9, wherein an electrolyte injection coefficient during a preparation process of the lithium ion battery is h, a ratio of a negative electrode capacity to a positive electrode capacity of the lithium ion battery is q, and a ratio of h to q ranges from 2.43 to 3.48.
